(19) United States
(12) Patent Application Publication
(10) Pub. No.: US 2025/0202149 A1
(43) Pub. Date: Jun. 19, 2025

(54) UNIVERSAL CONNECTOR FOR EXCHANGING DATA AND VOLTAGE AMONG MULTIPLE ELECTRONIC DEVICES

(71) Applicant: Tusi, LLC, Lafayette, IN (US)

(72) Inventors: Jurgen ZACH, Lafayette, IN (US); Karun TAHILRAMANI, Chesapeake, VA (US)

(21) Appl. No.: 18/843,681

(22) PCT Filed: Mar. 1, 2023
(86) PCT No.: PCT/US2023/014309

§ 371 Date: Sep. 5, 2024

Related U.S. Application Data
(60) Provisional application No. 63/315,406, filed on Mar. 1, 2022.

(51) Int. Cl. H01R 13/17; H01R 13/62; H02J 7/00

(52) U.S. Cl. CPC H01R 13/17; H01R 13/6205; H02J 7/0042

(57) ABSTRACT

A universal connector for exchanging data and voltage among multiple devices is disclosed. The universal connector comprises a processing unit having at least one wired data interface having at least two wires and a plurality of terminals including a first set of terminals having at least two terminals connected to at least two wires of the at least one wired data interface and a second set of terminals having at least two terminals connected to a pair of voltage terminals. The first set of terminals transmit signals between the processing unit of one electronic device to the processing unit of another electronic device. An energy storage unit stores energy to power the processing unit. The electronic device with the energy storage unit that is less depleted recharges another electronic device with the energy storage unit that is more depleted via the pair of connected voltage terminals.

### TECHNICAL FIELD

The present invention generally relates to the field of electronics. More specifically, the present invention relates to a universal connector configured to exchange data and voltage between multiple electronic devices.

### BACKGROUND

There is an urgent and growing need for universal electrical connectors that can facilitate data connections, or electrical power connections, or both, between multiple electrical conductors or contacts attached to two electronic devices or two cables. The universal connectors are also used to facilitate data connections and/or electrical power connections from an electric load to a power supply, or for any other application which can make use of creating a galvanic or conductive connection between two sets of conductors.

The existing electrical connectors face the shortcoming to be limited to sets (pairs) of complementary connectors that do not allow, for example, connections from a “male” to a “male” connector, or between two connectors with only flat contacts, or between two connectors with only spring-loaded pins. In general, present connector pairs consist of one connector type “A” connecting with a different connector type “B”, and connections between two “A”-connectors or between two “B”-connectors are not possible.

Therefore, there is a need for a universal connector configured to exchange data and voltage between multiple electronic devices. Also, there is a need for a universal connector to facilitate effective connections between identical or very similar connectors.

### SUMMARY

The present invention generally discloses a universal connector to exchange data and voltage between multiple electronic devices. Also, the present invention discloses a universal connector to facilitate effective connections between identical such as pairs of female/male connectors, or sets of a connector and receptacle, or between protruding pins and recessed receptacles, or between spring-loaded pins (“pogo-pins”) and flat contacts.

In an exemplary embodiment, the universal connector is used for connecting multiple electronic devices for exchanging data and voltage. In one embodiment, one electronic device is connected to another electronic device using a pair of connectors. The pair of connectors are connected through a unique configuration. In one embodiment, the pair of connectors are identical and include a plurality of connections to a plurality of conductors using a plurality of terminals. In one embodiment, one half of the plurality of terminals in each connector are connected to one or more spring-loaded pins, and another half of the plurality of terminals in each connector are connected to one or more exposed contacts. In one embodiment, each connector is symmetric with respect to a point in the center of the connector, for each spring-loaded pin at a location relative to the center of the connector, and the exposed contact is located at the respective opposing point relative to the center of the connector, and vice versa.

In one embodiment, the universal connector comprises a processing unit. The processing unit includes at least one wired data interface having at least two wires. The at least two wires of the at least one data interface are universal asynchronous receiver-transmitter (UART). In one embodiment, the universal connector further comprises a plurality of terminals. The plurality of terminals includes a first set of terminals and a second set of terminals. The first set of terminals include at least two terminals connected to at least two wires of the at least one wired data interface. The second set of terminals include at least two terminals connected to a pair of voltage terminals. In one embodiment, the first set of terminals is configured to transmit signals between the processing unit of one electronic device to the processing unit of another electronic device. In one embodiment, the signals are transmitted via at least one wired data interface. The transmission of signals between the processing units is fully independent of the relative orientation of the connectors without any software or hardware reconfiguration.

In one embodiment, the universal connector further comprises an energy storage unit configured to store energy to power the processing unit. In one embodiment, the electronic device with the energy storage unit that is less depleted recharges another electronic device with the energy storage unit that is more depleted via the pair of connected voltage terminals. In one embodiment, the universal connector further comprises a circuitry to recharge the energy storage unit using an external power source.

In one embodiment, the universal connector further comprises a data exchange unit configured to exchange data. The exchange of data includes transmitting or receiving a unique identification of the device or node unit, and other data to be relayed to other devices or node units, and yet other data received from the other connected devices or node units.

In some other embodiments, the universal connector comprises a plurality of conductors connected together using a pair of connectors with a plurality of terminals. The plurality of conductors are electrically connected through a pair of identical connectors with the plurality of terminals. In one embodiment, one half of the plurality of terminals in each connector are connected to a spring-loaded pin, and another half of the terminals in each connector are connected to an exposed contact.

Each connector is symmetric with respect to a point in the center of the connector. In one embodiment, the two connectors mate by the electrical connection between the spring-loaded pin on one connector and the exposed contact on the other connector, and vice versa. For each spring-loaded pin at a location relative to the center of the connector, an exposed contact is located at the respective opposing point relative to the center of the connector, and vice versa.

In one embodiment, an even number of conductors are electrically connected using a pair of connectors with a “N” number of terminals. One half (N/2) of the terminals in each connector are connected to a spring-loaded pin, and another half (N/2) of the terminals in each connector are connected to an exposed contact. In one embodiment, each spring-loaded terminal on one connector is in contact with an exposed contact, and vice versa. The mating connectors establish electrical contacts through all terminals through compression of the springs. In one embodiment, the plurality of terminals includes any one of an oval or circular cylinders with flat, non-rounded tips.

In one embodiment, each connector comprises a magnet with “North” polarity on one location, and a magnet with “South” polarity on the opposing point relative to the symmetry point at the center of the connector. In one embodiment, the two connectors mate by the “North” magnet on one connector being attracted to the “South” magnet on the other connector, and vice versa.

In one embodiment, the connector further comprises a protruding mechanical structure in one location. In one embodiment, the connector further comprises a recessed mechanical structure complementary to the protruding mechanical structure on the opposing point relative to the symmetry point at the center of the connector. In one embodiment, the two connectors mate by the protruding structure on one connector being inserted into the corresponding recessed structure on the other connector and held in place through friction, and vice versa.

The above summary contains simplifications, generalizations, and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the following figures and detailed written description.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 is a top isometric view of a flat cuboid device with an example universal connector that connects with an identical connector, in accordance with the present disclosure.

FIGS. 2A and 2B are top isometric views of an example set of devices connected by one or more universal connectors, according to one embodiment of the present invention.

FIG. 3 is a top view of two example devices with universal connectors establishing mechanical and electrical connections, according to one embodiment of the present invention.

FIGS. 4A, 4B, 4C, and 4D are each top views of example devices with universal connectors in different connection orientations, in accordance with the present disclosure.

FIG. 5 shows two devices with an example universal connector configuration for the exchange of data and power, according to one embodiment of the present invention.

FIG. 6 shows two devices with another example universal connector configuration for the exchange of data and potentially power, according to another embodiment of the present invention.

FIG. 7 shows a device with universal connectors that offer rotational degrees of freedom with adjustable angles between two devices, according to one embodiment of the present invention.

FIGS. 8A-8B show side views of the devices with universal connectors with adjustable angle through rotational degrees of freedom around an axis, according to one embodiment of the present invention.

FIG. 9 shows the node unit with multiple universal connectors based on concentric cylindrical electrodes, according to one embodiment of the present invention.

FIG. 10 shows a side perspective view of the device comprised of concentric electrodes that protrude from the surface enabled through mechanical means, according to one embodiment of the present invention.

FIG. 11 shows a universal connector enabling the assembly of complex 3D shapes out of devices, according to one embodiment of the present invention.

FIG. 12 shows multiple concentric universal connectors with mechanical connections, according to one embodiment of the present invention.

FIG. 13 shows a fully rotationally symmetric universal connector, according to one embodiment of the present invention.

FIG. 14 shows an another fully rotationally symmetric universal connector, according to another embodiment of the present invention.

### DETAILED DESCRIPTION OF EXAMPLE EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

As used herein, the term “Connections” (or singular “Connection”) is defined, unless specified otherwise, as electrically conductive pathways established between two sets of conductors for the purposes of the transmission of electrical power of the exchange of data.

As used herein, the term “Universal Connector” (plural “Universal Connectors”) defines as a connector which allows the establishment of connections between two identical or functionally identical connectors.

As used herein, the term “Node Units” (singular “Node Unit”) is defined as sets of identical or functionally similar electronic devices that may continuously, occasionally, or from time to time, exchange electric power and/or data through wired connections, and that benefit from the use of Universal Connectors to accomplish Connections among Node Units from any Universal Connector to any other Universal Connector, wherein Node Units may include at least one Universal Connector each.

As used herein, the term “wired” is to be understood in the widest sense as describing a continuous conductive pathway, such as facilitated by connectors, and shall include imperfect electrical connections or instances of higher contact resistance.

According to the present invention, a universal connector for exchanging data and voltage among multiple devices is disclosed. The universal connector facilitates effective connections between identical or very similar connectors. The universal connector provides connections between identical connectors, such as pairs of female/male connectors, or sets of a connector and receptacle, or between protruding pins and recessed receptacles, or between spring-loaded pings (“pogo-pins”) and flat contacts.

The present disclosure will, in more detail, describe examples in which data and/or power connections through electrical conductors (collectively defined henceforth as “Connections”) are enabled between at least two identical or similar electronic devices in identical or similar enclosures (collectively defined henceforth as “node units”). Each node unit has at least one connector, and multiple node units have identical connectors. It is desirable to connect any of the at least one connector on one node unit to any one from among at least one connector on another node unit. In one embodiment, two node unit or more than two node units may be connected together using at least two connectors.

In one embodiment, the universal connector of the present invention is useful and shall cover any application for any connector pairs, not just between identical or similar node units, but among any devices or sets of wires or cables. There is a cost-benefit to be realized by consolidating the number of part numbers or component counts, when, instead of two complementary connectors, two identical connectors can be utilized to achieve a connection.

Many examples used in the present invention focus on spring-loaded contacts (e.g., “pogo-pins”) pushing onto flat contacts to accomplish electrical connections. This shall not indicate a limitation on such combinations, but it shall be understood that any pair of complementary electrical contacts (e.g., cylindrical connector) and cylindrically shaped recess, or any other complementary geometric shapes, or identical electrical contacts (e.g., two spring-loaded cylindrical contacts pushing on each other), or dissimilar electrical contacts shall be covered.

In an example embodiment, the universal connector is used for connecting multiple electronic devices for exchanging data and voltage. In one embodiment, one electronic device is connected to another electronic device using a pair of connectors. The pair of connectors are connected through a unique configuration. In one embodiment, the pair of connectors are identical and include a plurality of connections to a plurality of conductors using a plurality of terminals. In one embodiment, one half of the plurality of terminals in each connector are connected to one or more spring-loaded pins, and another half of the plurality of terminals in each connector are connected to one or more exposed contacts. In one embodiment, each connector is symmetric with respect to a point in the center of the connector, for each spring-loaded pin at a location relative to the center of the connector, and the exposed contact is located at the respective opposing point relative to the center of the connector, and vice versa.

In one embodiment, the universal connector comprises a processing unit. The processing unit includes at least one wired data interface having at least two wires. The at least two wires of the at least one data interface are universal asynchronous receiver-transmitter (UART). In one embodiment, the universal connector further comprises a plurality of terminals. The plurality of terminals includes a first set of terminals and a second set of terminals. The first set of terminals include at least two terminals connected to at least two wires of the at least one wired data interface. The second set of terminals include at least two terminals connected to a pair of voltage terminals. In one embodiment, the first set of terminals is configured to transmit signals between the processing unit of one electronic device to the processing unit of another electronic device. In one embodiment, the signals are transmitted via at least one wired data interface. The transmission of signals between the processing units is fully independent of the relative orientation of the connectors without any software or hardware reconfiguration.

In one embodiment, the universal connector further comprises an energy storage unit configured to store energy to power the processing unit. In one embodiment, the electronic device with the energy storage unit that is less depleted recharges another electronic device with the energy storage unit that is more depleted via the pair of connected voltage terminals. In one embodiment, the universal connector further comprises a circuitry to recharge the energy storage unit using an external power source.

In one embodiment, the universal connector further comprises a data exchange unit configured to exchange data. The exchange of data includes transmitting or receiving a unique identification of the device or node unit, and other data to be relayed to other devices or node units, and yet other data received from the other connected devices or node units.

In some other embodiments, the universal connector comprises a plurality of conductors connected together using a pair of connectors with a plurality of terminals. The plurality of conductors are electrically connected through a pair of identical connectors with the plurality of terminals. In one embodiment, one half of the plurality of terminals in each connector are connected to a spring-loaded pin, and another half of the terminals in each connector are connected to an exposed contact.

Each connector is symmetric with respect to a point in the center of the connector. In one embodiment, the two connectors mate by the electrical connection between the spring-loaded pin on one connector and the exposed contact on the other connector, and vice versa. For each spring-loaded pin at a location relative to the center of the connector, an exposed contact is located at the respective opposing point relative to the center of the connector, and vice versa.

In one embodiment, an even number of conductors are electrically connected using a pair of connectors with a “N” number of terminals. One half (N/2) of the terminals in each connector are connected to a spring-loaded pin, and another half (N/2) of the terminals in each connector are connected to an exposed contact. In one embodiment, each spring-loaded terminal on one connector is in contact with an exposed contact, and vice versa. The mating connectors establish electrical contacts through all terminals through compression of the springs. In one embodiment, the plurality of terminals includes any one of an oval or circular cylinders with flat, non-rounded tips.

In one embodiment, each connector comprises a magnet with “North” polarity on one location, and a magnet with “South” polarity on the opposing point relative to the symmetry point at the center of the connector. In one embodiment, the two connectors mate by the “North” magnet on one connector being attracted to the “South” magnet on the other connector, and vice versa.

In one embodiment, the connector further comprises a protruding mechanical structure in one location. In one embodiment, the connector further comprises a recessed mechanical structure complementary to the protruding mechanical structure on the opposing point relative to the symmetry point at the center of the connector. In one embodiment, the two connectors mate by the protruding structure on one connector being inserted into the corresponding recessed structure on the other connector and held in place through friction, and vice versa.

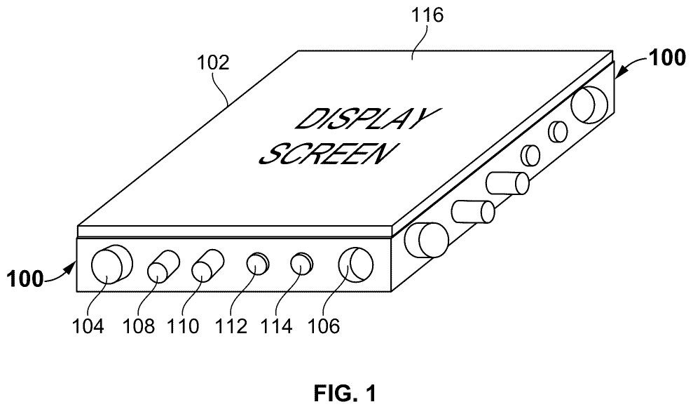

Referring to FIG. 1, a universal connector 100 connected to a flat cuboid device or node unit (hereinafter referred as node unit) 102 in a typical use case is illustrated. In one embodiment, the universal connector 100 may be an identical connector. The node unit 102 is connected with four universal connectors on four sides. The node unit 102 has a node unit having a height that is much smaller than its width and length. In one embodiment, the universal connector 100 comprises one or more electrical connections. In one embodiment, the universal connector comprises at least one protruding element 104 and a recessed element 106. In an exemplary embodiment, the universal connector 100 further comprises four electrical connections (N=4). The four electrical connections include two spring-loaded pins (108 and 110) and two flat conductors or conductive pads (112 and 114). The node unit 102 comprises a display screen 116 on its top side. In one embodiment, the node units 102 could be enabled by the universal connectors 100. In one embodiment, multiple node units 102 could be assembled to form complex connected grids with peer connections. The peer connections may serve a useful purpose such as a composite display screen, or any other purpose served by connecting multiple node units 102.

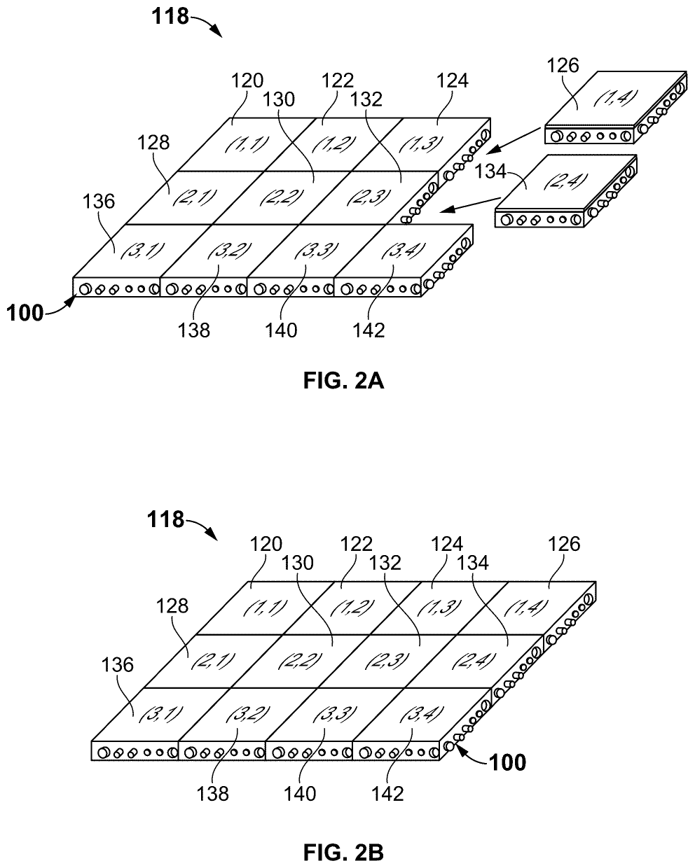

Referring to FIGS. 2A-2B, a grid pattern 118 of multiple node units (120, 122, 124, 126, 128, 130, 132, 134, 136, 138, 140, and 142) is disclosed. The node units (126 and 134) are missing from the grid pattern 114 and the remaining node units (120, 122, 124, 126, 128, 130, 132, 134, 136, 138, 140, and 142) are mechanically attached as shown in FIG. 2A. The grid pattern 118 is fully assembled as shown in FIG. 2B. In one embodiment, the node units (120, 122, 124, 126, 128, 130, 132, 134, 136, 138, 140, and 142) are used to detect the establishment of a connection and to exchange data. In one embodiment, the exchanged data may include transmitting or receiving a unique identification of one node unit, and other data to be relayed to other node units, and yet other data received from connected node units.

In various embodiments, the connected node units (120, 122, 124, 126, 128, 130, 132, 134, 136, 138, 140, and 142) further allow for the exchange of stored electric energy from one node unit to a connected node unit. In some embodiments, the wireless identification of the connected node units (120, 122, 124, 126, 128, 130, 132, 134, 136, 138, 140, and 142) is possible, as it is a wireless power transfer. In some embodiments, wired connections to identify connected devices or node units are more reliable than, and wired power exchange is far more efficient than wireless power transfer.

In one embodiment, the wired connection is established by two spring-loaded pins (“pogo-pins”) (108 and 110) and two conductive pads (112 and 114) on each connecting side. When connecting, the pogo-pins (108 and 110) on one node unit 102 mate with the conductive pads (112 and 114) on the connecting, and vice versa.

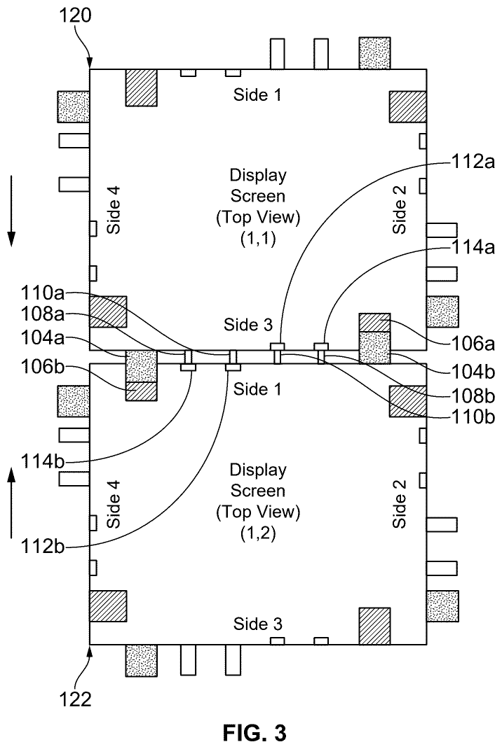

Referring to FIG. 3, two node units (120 and 122) with universal connectors 100 configured to establish mechanical and electrical connections are disclosed. Each node unit (120 and 122) is connected with a universal connector 100 on each of the four sides. Each universal connector 100 comprises a protruding mechanical connecting element 104, a pair of spring-loaded electrically conductive pins or pogo-pins or protruding electrical connectors (108 and 110), a pair of flat conductors or recessed electrical contacts or recessed electrical connectors (112 and 114), and a recessed mechanical connecting element 106. In some embodiments, the protruding mechanical connecting element 104 is a magnet of one polarity, and/or may also be a conductive element (i.e., comprises a part of a connection). In some embodiments, the recessed mechanical connecting element 106 is a magnet of the opposite polarity, and may also be electrically conductive element (i.e., comprises a part of a connection).

In one embodiment, the first node unit 120 mates with side-1 of the second node unit 122, wherein the protruding mechanical element 104a of the first node unit 120 connects with the recessed mechanical element 106b of the second node unit 122. The protruding mechanical element 104b of the second node unit 122 connects with the recessed mechanical element 106a of first node unit 120. In a specific embodiment, the above both mechanical connections may be sustained through magnetic attraction or through mechanical means such as friction. The mechanical connectors (104a, 104b, 106a, and 106b) may not rely on protruding and recessed shapes and maintained in place by magnets.

In some embodiments, the both mechanical connections may also include electrical connections. In one embodiment, the protruding electrical connectors (108b and 110b) of the second node unit 122 establish connection with the flat or slightly recessed contacts (114a and 112a) of the first node unit 120. The protruding electrical connectors (108a and 110a) of first node unit 120 connect with the flat or slightly recessed electrical contacts (114b and 112b) of the second node unit 122.

In some embodiments, a specific relative rotational orientation of two node units is required, either arising through geometric constraints of only one pair of sides of two node units by fitting together, or through the definition of a predefined direction along which all node units are configured to be aligned.

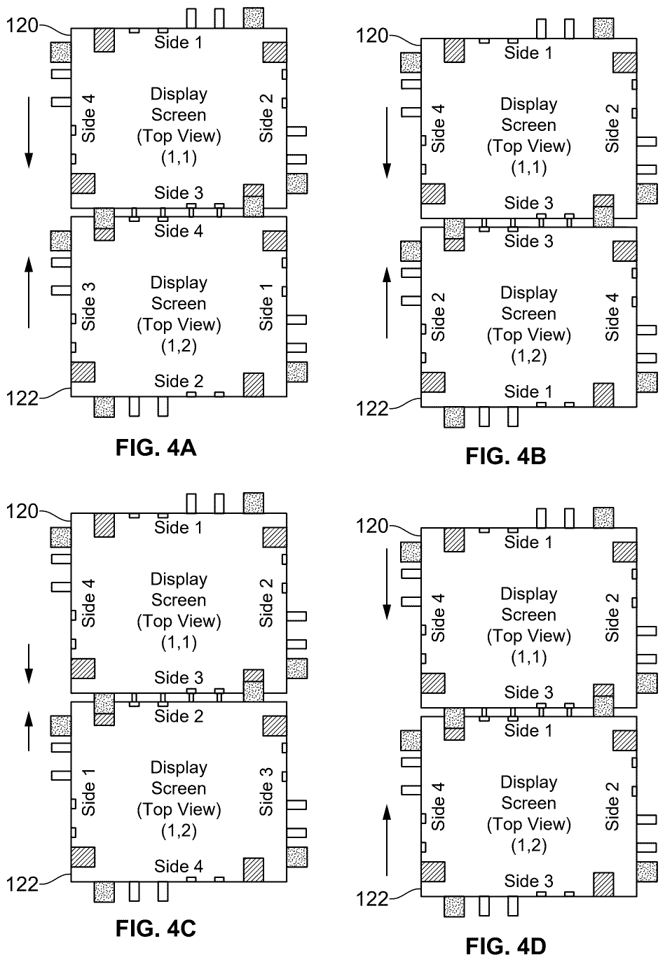

Referring to FIGS. 4A-4B, different orientations to universally connect the node units (120 and 122) are disclosed. In some embodiments, the node units (120 and 122) with square shapes can connect with any relative orientation, which shows two node units (120 and 122) completing equivalent connections along four sides. In some embodiments, the node units (120 and 122) are rectangular, but not square and flat cuboids. In these embodiments, all sides cannot be connected to each other. Only Side 2 is connected with 4 or Side 1 is connected with Side 3 of node units (120 and 122). If Sides 2 and 4 are equal to each other, but different from Sides 1 and 3, which are, in turn, equal.

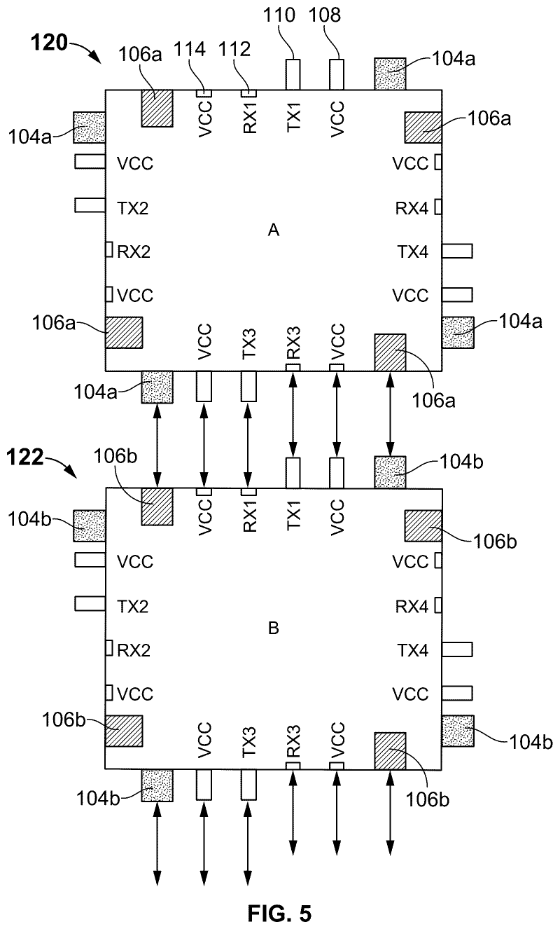

Referring to FIG. 5, two node units (120 and 122) with one possible universal connector configuration for the exchange of data and power is disclosed. In an embodiment, two connected node units (120 and 122) exchange both data and stored power. The protruding and recessed mechanical connectors (104a, 106a, 104b, and 106b) also serve as local electric ground for the node units (120 and 122). When connected, both node units (120 and 122) thus share a same ground. In some embodiments, the ground is a power ground. In other embodiments, the ground is a signal ground. In yet other embodiments, the ground is both the signal and power ground.

The far right-sided protruding or pogo-pin 108, as well as the far left-sided flat or slightly recessed electrical contact 114 serve as voltage rail for power (“VCC”). The VCC pins (108 and 114) and GND-pins (104a, 106a, 104b, and 106b) of node units (120 and 122) are connected through two redundant connections. The second protruding or pogo-pin 110 from the right on each connector serves as data transmission pin, and the second flat or slightly recessed electrical contact 112 serves as data receiving pin. When connected, each transmitting pin of a connector is connected to the receiving pin, that is TX1 of the second node unit 122 is connected to RX3 of the first node unit 120, and RX1 of the second node unit 122 is connected to TX3 of the first node unit 120.

In one embodiment, the connected node units (120 and 122) communicate through serial peer-to-peer communications, in which connected node units (120 and 122) act as equal communication nodes. Among commercially available protocols, Universal Asynchronous Receiver/Transmitter (UART) can be readily applied, if the UART is run in full duplex mode. UART interfaces can rely on two to four wires, wherein the minimum set of wires is a transmitter (TX) and receiver (RX) on each communication node unit, which are connected to the respective RX and TX of the communication partner node in a cross-over wiring. Optionally, two additional UART wires, such as RTS (Request to Send) and CTS (Clear to Send) are used if both communication nodes (120 and 122) are capable of full-duplex nodes, that is, sending and receiving data simultaneously.

In FIG. 5, RTS and CTS are omitted. In one embodiment, the RTS and CTS may be added as an additional (protruding pin/flat contact) pair on each universal connector side of the node units (120 and 122). Analogous to TX and RX, RTS may be connected to the protruding or pogo-pin 108, and CTS may be connected to a symmetrically located flat contact 114 (or vice versa). In one embodiment, when the two node units (120 and 122) are connected, the RTS of one node unit would be connected to the CTS of its connected peer partner. This configuration utilizes USART (Universal Synchronous/Asynchronous Receiver/Transmitter).

In some embodiments, any other peer-to-peer serial communications protocol other than UART can be employed for two connecting node units (120 and 122) to communicate with the identical or similar universal connector pin. For example, legacy communications protocols such as RS-232 are readily implemented in the configuration, as RS-232 can also be operated in peer-to-peer mode. In some embodiments, the RS-232 protocols may communicate similar to other communications protocols. In one embodiment, the RS-232 can provide customized communications that make use of two wires, a transmitter (TX) and a receiver (RX) wire, in each universal connector 100. Examples of the latter are customized “bit-banging” protocols, or “bit-banging” simulating standard communications protocols, where communications are fully controlled by transmissions controlled down to the bit level in software.

In some embodiments, the VCC connections (108 and 114) are only needed in which the node units (120 and 122) have a power connection, such as to share power among connected Node Units to avoid individual node units depleting their battery charge at uneven rates. In some embodiments, GND connections (104a, 106a, 104b, and 106b) are needed for serial communications in which the serial communications protocol is not isolated. In isolated configurations, that is, if two communications ports do not share the same ground, the GND connection is not needed. Isolated connections are part of strategies to protect connected devices from failures in one node damaging connected nodes by helping avoid high voltages relative to a local ground, with the tradeoff, however, of reduced efficiency and higher component costs. Therefore, some embodiments that prioritize manufacturing costs will aim at providing a ground connection between connected node units, especially as it is needed anyway for Node Units to exchange stored battery power.

The connection mechanism between node units (120 and 122) is not limited to a specific number of wired connections. In some embodiments, the universal connector 100 utilizes any combination of connection terminals in which complementary connector functions are arranged symmetrically with respect to the center of a connecting surface. The term “complementary” defines a connection terminal in the first node unit 120 needing to be in contact with its complementary equivalent connection terminal from the connecting node unit or second node unit 122. The complementary connection terminals also have complementary mechanical functions (e.g., male/female connectors; or pogo pins/flat contacts).

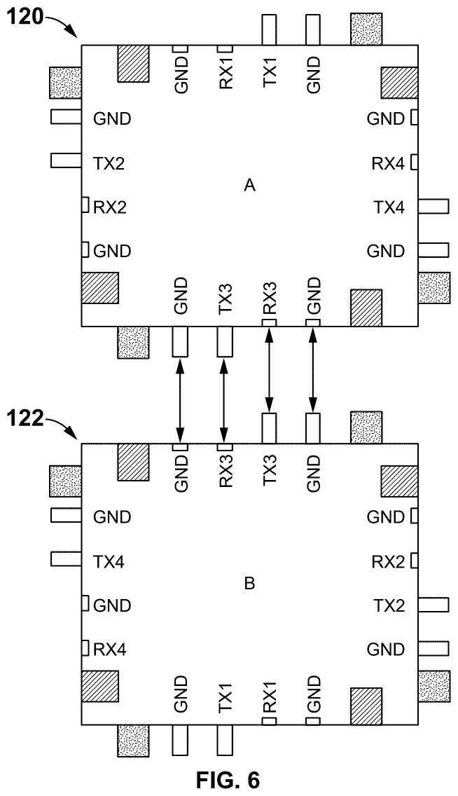

Referring to FIG. 6, two node units (120 and 122) with another possible universal connector configuration for the exchange of data and potentially power is disclosed. The central protruding and recessed electrical contact pins (TX1, RX1, TX2, RX2, TX3, RX3, TX4, and RX4) at each side performs the same data connection functions as described in FIG. 5. Also, the far-left and far-right electrical connection terminals are connected to ground (“GND”). In some embodiments, power is exchanged between the connected node units by harvesting power from the data connection terminals TX and RX.

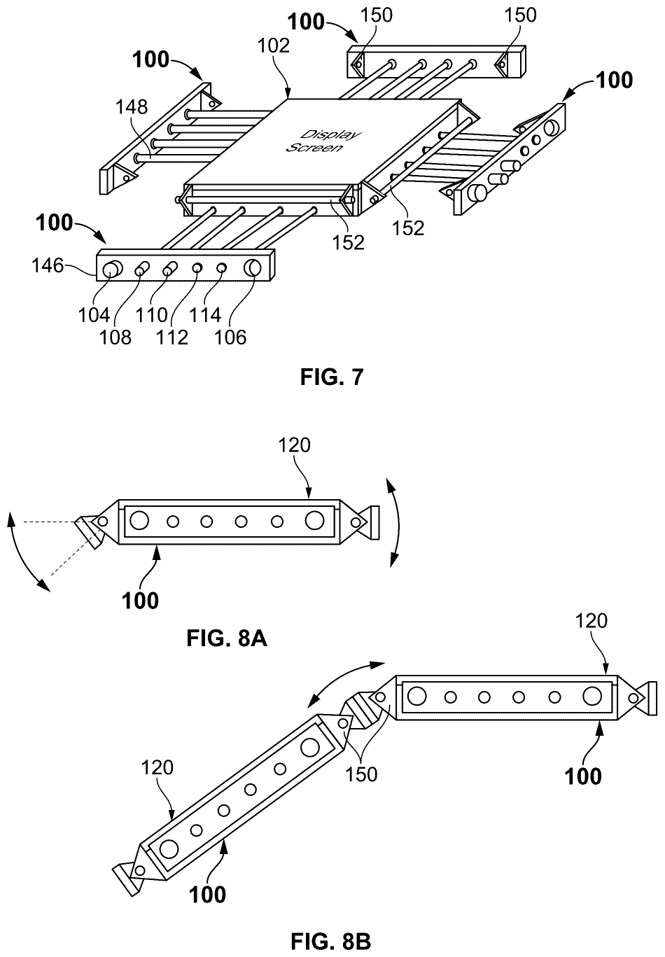

Referring to FIG. 7, the first node unit 120 with multiple universal connectors 100 to provide a three-dimensional (3D) structure is disclosed. In some embodiments, the universal connectors 100 are used to build the 3D structures. The universal connectors 100 offer rotational degrees of freedom with adjustable angles between two node units. The universal connectors 100 allow connecting directions of two node units other than in the plane of the largest surface of a flat cuboid. The universal connectors 100 are mounted on an element 146 that is not rigidly attached to the first node unit 120. The universal connector 100 comprises one or more Connection elements which may include mechanical connection elements (104 and 106) and/or electrical connection elements or contacts (108, 110, 112, and 114). The functions and relative positions of protruding versus recessed mechanical connectors (104 and 106), as well as protruding electrical contacts or “pogo”-pins (108 and 110) versus flat or recessed electrical contacts (112 and 114) are substantially the same or similar to embodiments such as shown in FIG. 1 and vary within the same configuration range.

For easier illustration, the elements 146 are drawn at an exaggerated distance from the first node unit 120 and are substantially closer to the sides of the first node unit 120 in almost all embodiments. For the same reason, one or more flexible contacts 148 are used that maintain electrical contact between the connection elements (104, 106, 108, 110, 112, and 114) on the elements 146 to the first node unit 120 are also drawn at an exaggerated length for illustration. The flexible contacts 148 may be embodied as any conductive element that can sustain repeated bending in a direction away from the plane of the largest cuboid surface, including but not limited to stranded wires, solid wires, ribbon cables, coaxial cables, and flexible printed circuit boards (PCB) with traces of copper, silver, or any conductive paint or epoxy on a flexible substrate such as polyimide (“Kapton”) or other flexible plastics.

The elements 146 are attached to the node unit 120 through one or more mechanical connections 150 that allow(s) movement around an axis 152 in or close to the larger top or bottom cuboid plane and along the edge of the first node unit 120. In one embodiment, the present invention covers any mechanical connection that satisfies the indicated freedom of motion, including but not limited to axles through plain bearings, rolling-element bearings such as ball bearings or roller bearings, and fluid bearings; at least one hinges per connector; flexible beams of material with memory such as made of rubbery materials which can bend, and flexible beams of bendable material without memory.

Referring to FIGS. 8A-8B, side views of the node units (120 and 122) with universal connectors 100 with adjustable angle through rotational degrees of freedom around the axis are disclosed. The resulting freedom of motion achieved with the embodiment in FIG. 7 is illustrated in FIG. 8, which demonstrates the ability of the mechanical connectors 150 to connect two node units (120 and 122), forming the basis to create Connections among electrically connected, three-dimensional structures.

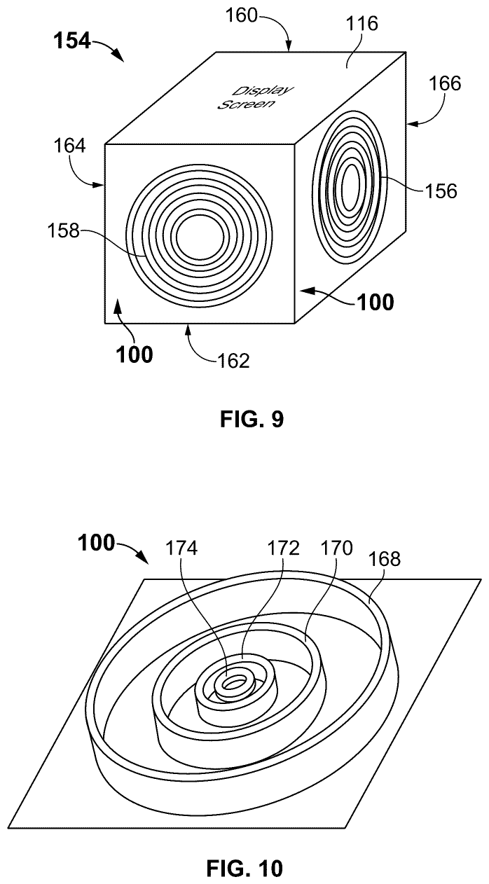

Referring to FIG. 9, a cuboid node unit 154 with multiple universal connectors 100 based on one or more concentric cylindrical electrodes is disclosed. In many embodiments, the universal connectors 100 are adapted to connect with the node units with different geometries that, likewise, provide for the effective connections using identical or functionally identical universal connectors. For example, a cuboid node unit 154 comprises at least two universal connectors 100 with spherical symmetry (156 and 158) and a display screen 116 on its top face 160. The bottom face 162 and side faces (164 and 166) may either contain display screens 116 or universal connectors 100. The universal connectors 100 are designed to establish electrical connections (Connections) with identical or functionally identical universal connectors on similar cuboids as shown in FIG. 9.

Referring to FIG. 10, a concentric universal connector 100 with exaggerated connector protrusions with one or more concentric rings is disclosed. The concentric universal connector 100 comprises four concentric pins (168, 170, 172, and 174). The pins (168, 170, 172, and 174) may be circular or cylindrical shell conductors that connect to corresponding circular universal conductors on another node unit the connector face mates with. To ensure electrical connection, the circular pins (168, 170, 172, and 174) are able to protrude from the connector face to connect with a connecting cuboid face. The circular pins (168, 170, 172, and 174) are able to extent out from the surface, sliding along a direction that is perpendicular to the surface. In one embodiment, the pins (168, 170, 172, and 174) may be spring-loaded, and/or may be able to slide freely. In some embodiments, the circular universal connectors may be partially or fully magnetized. In many embodiments, not all pairs of connector faces will be able to mate with all other, if the polarity of a magnet is fixed, for example if magnetization is created through a permanent magnet.

For example, the first two pins (168 and 170) may contain an outward facing “N” polarity, and the remaining two pins (172 and 174) may contain an “S” polarity. That connector face can only effectively mate with a connector side in which the pins (168 and 170) contain an outward facing “S” polarity, and the pins (172 and 174) contain an “N” polarity. The polarities mentioned are only exemplary, and any combination of polarities in the circular pin connectors may be implemented. In other embodiments, the electrical connection may be fully assured through mechanical means to avoid the magnetic polarity issue. The assignment of the pins (168, 170, 172, and 174) may be similar to flat cuboids, or different. For example, the first pin 168 may be ground “GND”, the second and third pin (170 and 172) may be “RX” and “TX”, respectively, in a serial wired interface, and the fourth pin 174 may be power, or “VCC”. The number of circular concentric pins may differ from four, or the assignment may be completely different.

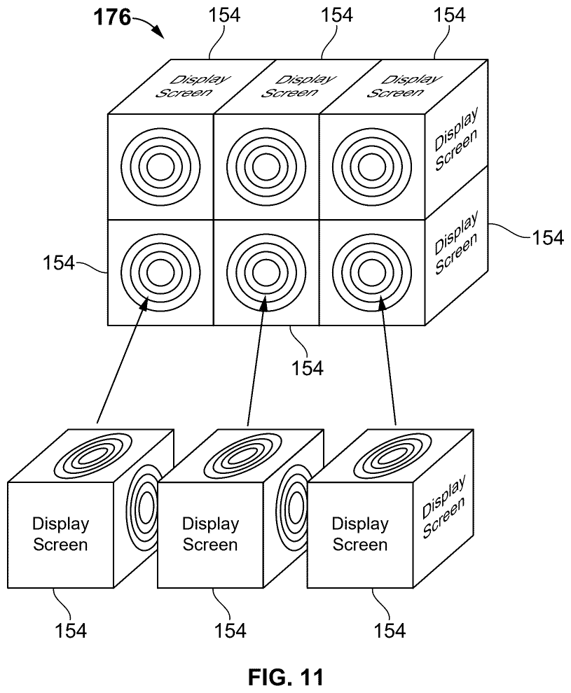

Referring to FIG. 11, the universal connector 100 enabling the assembly of complex 3D shape 176 using multiple node units 154 is disclosed. A set of multiple node units 154 are assembled into larger 3D shape 176. The physical attachment between connected node units 154 for various embodiments similar to FIG. 9 can be accomplished by a variety of connections. In one embodiment, the connection between the node units 154 may be mechanical connections, held in place by friction forces. In another embodiment, the connection between the node units 154 may be magnetic connections.

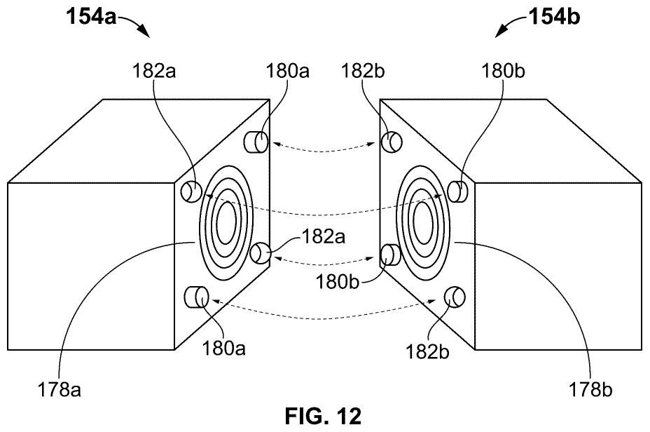

Referring to FIG. 12, the connection process of two cuboid node units (154a and 154b) is disclosed. In one embodiment, the cuboid node units (154a and 154b) are connected using an electrical connection (178a and 178b). In another embodiment, the cuboid node units (154a and 154b) are connected using any other connection mechanism. The mechanical connection mechanism relies on mechanical protrusions on one connecting side or connector mating with complementary recesses on the other connecting side or connector.

In one embodiment, the first cuboid node unit 154a comprises two protrusions 180a and two recesses 182a. In one embodiment, the connecting cuboid node unit 154b comprises two protrusions 180b and two recesses 182b. The two protrusions 180a of the first cuboid node unit 154a are compatible with the recesses 182b of the connecting cuboid node unit 154b. The two recesses 182b of the connecting cuboid node unit 154b are compatible with the two protrusions 180a of the first cuboid node unit 154a. For a rotationally symmetric universal connector shown in FIG. 10, any two node units can connect in two different orientations separated by 180 degrees with the specific embodiment shown in FIG. 12. In some embodiments, any other symmetry property could also be used. In an alternative embodiment, the connection between the cuboid node units (154a and 154b) could be established using magnetic connectors instead of mechanical friction. For magnetic connectors, the protrusions (180a and 180b) could be replaced with a magnet with one polarity, and the recessions (182a and 182b) could be replaced with a magnet of opposite polarity.

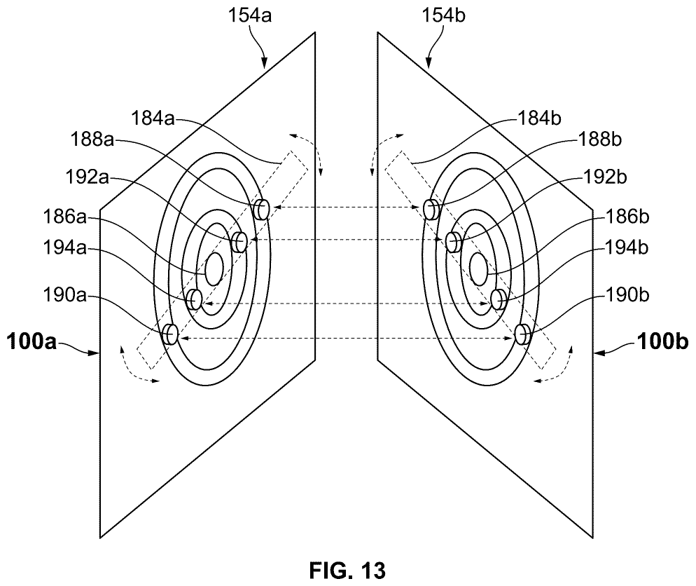

Referring to FIG. 13, a fully rotationally symmetric universal connector 100 according to one embodiment is disclosed. In an embodiment, the two node units (154a and 154b) are connected with full rotational symmetry in both electrical connection and physical attachment of two universal connectors 100a and 100b. Each universal connector (100a and 100b) has a rotating bar or functionally similar mechanical shape (184a and 184b), that rotates around an axis (186a and 186b), respectively. The rotating bars (184a and 184b) are inside the surface of the node units (154a and 154b). Each rotating bar (184a and 184b) has negative (188a and 188b) and positive (190a and 190b) polarity magnets mounted, which may reach to or near the surface of the node unit, and which are able to freely rotate inside a partially or fully circular channel symbolized by white circles on both node units (154a and 154b). The first pair of magnet polarity (188a and 190a) rotate within a channel with the same radius as the second pair of magnet polarity (188b and 190b). It should be understood that this is one example and that other embodiments may contain a different number of electrical connections.

In one embodiment, each rotating bar (184a and 184b) further comprises two electrical connection terminals (192a and 194a) or (192b and 194b). When two such universal connectors mate, the rotating bars (184a and 184b) rotate such that the first negative polarity 188a will face the second positive polarity 190b and the second negative polarity 188b will face the first positive polarity 190a, resulting in an electrical connection between the two terminals (192a and 194b) and (192b and 194a), respectively, Further, a peer 2-wire connection could be enabled such as UART which takes place regardless of the orientation of the node units (154a and 154b).

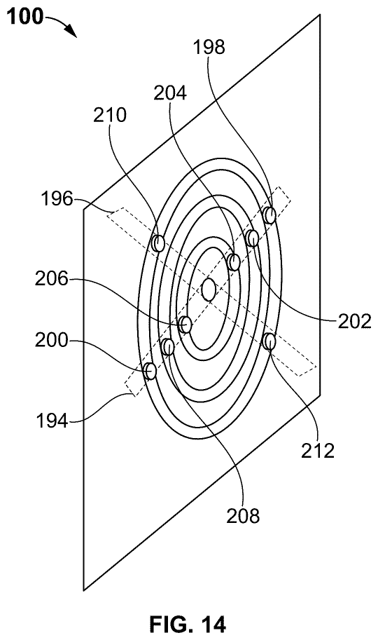

Referring to FIG. 14, an another fully rotationally symmetric universal connector 100 according to another embodiment is disclosed. In one embodiment, the full rotational equivalence can be readily generalized by adding more electrical contacts on each rotating bar (194 and 196). In one embodiment, the full rotational equivalence can be readily generalized by adding an extra bar with more contacts. In one embodiment, the first rotating bar 194 comprises a north polarity 198, a south polarity 200, and four electrical contacts (202, 204, 206, and 208), and the second rotating bar 196 has two additional electrical contacts (210 and 212).

In one embodiment, the universal connector includes methods, systems, and devices including some or all of the following features: a number of conductors that are electrically connected using a connector and another connector with terminals shaped like oval or circular cylinders. In one embodiment, N1 number of the terminals in the connector are connected to a spring-loaded conductive oval or circular cylinder, and N2 number of the terminals in the connector are connected to an oval or circular exposed contact. In another embodiment, the N2 number of the terminals in another connector are connected to a spring-loaded conductive oval or circular cylinder, and N1 number of the terminals in another connector are connected to an oval or circular exposed contact. In one embodiment, the mating connectors complement each other in that, when mating, each spring-loaded terminal on one connector is in contact with an exposed contact, and vice versa.

In one embodiment, the universal connector further includes methods, systems, and devices including some or all of the following features: one or more electrical connections are established through at least two wires between at least two enclosures through a pair of mating connectors. In one embodiment, the enclosures are shaped like prisms or nearly like prisms with the top and bottom polygon congruent or almost congruent. In one embodiment, the enclosures are substantially flat so that the thickness of the polygon is smaller than any side length of the top and bottom polygons. In one embodiment, the mating connectors on each enclosure are one of at least one connector attached to at least one side of each prism. In one embodiment, each connector is attached to a side of a prism through mechanisms. The mechanisms allow the connector orientation to change by swiveling around an axis that is parallel to the side the connector is attached to. With the orientation of a connector defined as the plane defined by the connector's swivel axis and the electrical connection points, it establishes with a mating connector.

In one embodiment, each connector plane is allowed to orient itself along a plane that is not parallel to the top or bottom of the prism-shaped enclosure it is attached to. In one embodiment, the connector on each enclosure is allowed to mate with a compatible connector that is oriented along a plane that is not parallel to the top or bottom of the prism-shaped enclosure it is attached to. In one embodiment, the connectors on two enclosures are allowed to mate while the top/bottom polygons of both enclosures are not parallel, thus allowing the construction of complex three-dimensional shapes by mating at least three enclosures with at least two connectors each.

In one embodiment, the universal connector also includes methods, systems, and devices including some or all of the following features: one or more electrical connections are established through at least two wires between at least two enclosures through a pair of mating connectors. In one embodiment, the enclosures are shaped like flat cuboids with the thickness smaller than any side length of the top and bottom rectangle. In one embodiment, at least one among the larger top- and bottom sides of each enclosure has a display screen mounted that displays a rectangular segment of a composite static or moving image, and the enclosure contains means to reconfigure the image displayed on the enclosures.

Each display screen is controlled by a processing unit inside the enclosure, that is connected to at least one wired data interface connected to the connectors that can mate with another enclosure. In one embodiment, the wired data interface is capable of transmitting and receiving instructions, through a connecter once mated with another connector, for the processing unit to modify at least one of the images displayed using part or all of the electrical connections established through the mating connectors. The mating connectors on each enclosure are one of at least one connector attached to each cuboid on at least one side that is not one of the larger top and bottom areas of the flat cuboid. For at least one configuration of connectors mating between a pair of cuboids, the display screens align with or without a gap between the display screens and with the aligned display screens in the same plane or not, and form a greater part or all of the composite image.

In one embodiment, the universal connector further includes methods, systems, and devices including some or all of the following features: a three-dimensional structure is completed by attaching at least three cuboids. In one embodiment, at least two if the totality of cuboids has at least one reconfigurable display screen each on at least one side. The cuboids with display screens include a processing unit and means to change a static or moving image displayed on any display screen on the cuboid. In one embodiment, the attachment of cuboids is accomplished by mating connectors. Each cuboid has at least one connector mounted on a side that can mate with at least one other connector on any other cuboid. In one embodiment, the connectors are attached to two different cuboid sides that are congruent and always compatible to mate. The connectors mating is comprised by forming a mechanical attachment that exerts an attractive force such as friction or magnetism once connectors are mated. An attempt is made to pull them apart with a force below a separation threshold.

In one embodiment, the connectors mating is further comprised by the formation of at least two electrical contacts between leads in mating connectors. In one embodiment, the compatible connectors are able to mate at least under the four different relative orientations, separated by 90 degrees from each other, of the cuboids at which the edges of the mating connector sides align. In one embodiment, the mechanical attachments and electrical connections are completely equivalent at least in the four equivalent orientations. In one embodiment, at least one data connection through a wired data interface with at least two wires is established between each pair of connected cuboids by mating connectors. Further, the processing units located in cuboids with display screens can transmit and receive data through a mated connector interface.

In addition, the universal connector of the present invention includes methods, systems, and devices including some or all of the following: a three-dimensional structure is completed by attaching at least three cuboids. In one embodiment, at least two of the totality of cuboids has at least one reconfigurable display screen each on at least one side. The cuboids with display screens include a processing unit and means to change a static or moving image displayed on any display screen on the cuboid. The attachment of cuboids is accomplished by mating connectors, with some connector pairs among the totality of connectors being compatible to mate. In one embodiment, the connectors mating is comprised by forming a mechanical attachment that exerts an attractive force such as friction or magnetism once connectors are mated and an attempt is made to pull them apart with a force below a separation threshold.

In one embodiment, the connectors mating is further comprised by the formation of at least two electrical contacts between leads in mating connectors. In one embodiment, the compatible connectors are able to mate at least under the four different relative orientations, separated by 90 degrees from each other, of the cuboids at which the edges of the mating connector sides align. The mechanical attachments and electrical connections are completely equivalent at least in said four equivalent orientations. In one embodiment, at least a data connection through a wired data interface with at least two wires is established between each pair of connected cuboids by mating connectors. Further, the processing units located in cuboids with display screens can transmit and receive data through a mated connector interface.

Advantageously, the universal connector of the present invention facilitates effective connections between identical or very similar connectors. The universal connector is utilized to exchange data and voltage among multiple electronic devices. The universal connector is useful and shall cover any application for any connector pairs, not just between identical or similar node units, but among any devices or sets of wires or cables. Further, there is a cost-benefit to be realized by consolidating the number of part numbers or component counts, when, instead of two complementary connectors, two identical connectors can be utilized to achieve a connection.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

What is claimed is:

1. A connector for connecting multiple electronic devices each having at least one of the connector, the connector comprising:
a plurality of terminals including:
a pair of terminals electrically connected to a processing unit of the corresponding electronic device, comprising one data transmitting terminal that is configured to facilitate outbound data transmission from the processing unit and one data receiving terminal that facilitates inbound data reception by the processing unit, each of the first pair of terminals being equidistant from a center point of the connector; and
two ground terminals electrically connected to a local electrical ground, wherein the two ground terminals are located equidistant from the center point of the connector; and
two voltage terminals electrically connected to a voltage relative to ground, the voltage supply connected to a voltage source of the corresponding electronic device, wherein the two voltage terminals are located equidistant from the center point of the connector;
wherein one of the pair of terminals, and one of the ground terminals, and one of the voltage terminals are each connected to a corresponding pin of a plurality of spring-loaded pins, and another of the pair of terminals, and another of the ground terminals, and another of the voltage terminals are each connected to a corresponding contact of a plurality of exposed contacts, the connector configured such that, when corresponding connectors of a first and a second of the electronic devices are connected to each other:
the data transmitting terminal among the pair of terminals of the connector corresponding to the first electronic device electrically connects to data receiving terminal of the connector corresponding to the second electronic device, wherein one of the connecting terminals is a spring-loaded pin and one is an exposed contact; and
the data receiving terminal among the pair of terminals of the connector corresponding to the first electronic device electrically connects to data transmitting terminal of the connector corresponding to the second electronic device, wherein one of the connecting terminals is a spring-loaded pin and one is an exposed contact; and
both of the two ground pins among the set of terminals of the connector corresponding to the first electronic device electrically connects to both of the two ground pins among the set of terminals of the connector corresponding to the second electronic device, wherein one of the connecting terminals is a spring-loaded pin and one is an exposed contact; and
both of the two voltage pins among the set of terminals of the connector corresponding to the first electronic device electrically connects to both of the two voltage pins among the set of terminals of the connector corresponding to the second electronic device, wherein one of the connecting terminals is a spring-loaded pin and one is an exposed contact.

2. The connector of claim 1, further comprising a protruding structure at a first location and a recessed structure at a second location opposing the first location relative to the center of the connector, the corresponding connectors of a pair of the electronic devices mating by the protruding structure on one of the connectors being inserted into the recessed structure on the other of the connectors and held in place through friction fit.

3. The connector of claim 1, further comprising a first magnet with “North” polarity at a first location and a second magnet with “South” polarity at a second location opposing the first location relative to the center of the connector, the corresponding connectors of a pair of the electronic devices mating by attractive force of the first magnet of one of the connectors with the second magnet of the other of the connectors.

4. A connector for connecting multiple electronic devices each having at least one of the connector, the connector comprising:
a plurality of terminals with an even count, wherein one half of the plurality of terminals comprise pogo terminals and the other half of the plurality of terminals comprise flat terminals, and for each pogo terminal disposed at a corresponding first location, a flat terminal is disposed at a second location opposing, relative to the center of the connector, the first location;
a plurality of spring-loaded pins each electrically connected to a corresponding one of the pogo terminals; and
a plurality of exposed contacts each electrically connected to a corresponding one of the flat terminals;
the connector configured such that, when corresponding connectors of a first and a second of the electronic devices are connected to each other, each pogo terminal on the connector corresponding to the first electronic device is connected to a flat contact on the connector corresponding to the second electronic device, and flat contact on the connector corresponding to the first electronic device is connected to a pogo terminal on the connector corresponding to the second electronic device, wherein electrical contact is established by the force of the spring-loaded pins comprising the pogo terminals.

5. The connector of claim 4, further comprising a first pair of mechanical features comprising a protruding structure in a third location and a recessed structure in a fourth location opposing, relative to the center of the connector, the third location, each protruding mechanical structure on the connector corresponding to the first electronic device mating by insertion into a corresponding recessed structure on the connector corresponding to the second electronic device and held in place through friction fit, and each recessed mechanical structure on the connector corresponding to the first electronic device mating by insertion of a corresponding protruding structure on the connector corresponding to the second electronic device and held in place through friction fit.

6. The connector of claim 4, further comprising a first pair of magnets comprising a “North” polarity magnet in a third location and a “South” polarity magnet in fourth location opposing, relative to the center of the connector, the third location, each magnet with one polarity on the connector corresponding to the first electronic device being in close proximity to a magnet with opposite polarity on the connector corresponding to the second electronic device, and held in place through an attractive magnetic force.

7. The connector of claim 4, wherein a two-wire data connection comprising a transmitter terminal and a receiver terminal are connected to a each of a pair of terminals, wherein one of the pair of terminals on a first location is connected to a spring-loaded pin and the other of the pair of terminals is connected to an exposed contact and located in a location that opposes the first location relative to the center of the connector.

8. The connector of claim 4, wherein at least two of the terminals in the connector correspond to a power source comprising two different voltage levels.

9. The connector of claim 4, wherein the connectors corresponding to both the first and second electronic devices include one ground terminal connected to a local electric ground and one voltage terminal connected to a voltage different from the local ground, wherein the voltage terminal and the ground terminal are at locations opposing each other relative to the center of the connector, wherein, in the process of the connectors corresponding to the first and second electronic devices connecting, the voltage terminal on the connector corresponding to the first electronic device mates with the ground terminal on the connector corresponding to the second electronic device, and the ground terminal on the connector corresponding to the first electronic device mates with the voltage terminal on the connector corresponding to the second electronic device.

10. The connector of claim 9, wherein, upon connecting, the assignment of the voltage terminal and ground terminal in the second connector is reversed such that, in the connected pair of connectors, the voltage terminal on the connector corresponding to the first electronic device is in electrical contact with the voltage terminal on the connector corresponding to the second electronic device, and the ground terminal on the connector corresponding to the first electronic device is in electrical contact with the ground terminal on the connector corresponding to the second electronic device.

11. The connector of claim 4, wherein the plurality of terminals includes any one of an oval or circular cylinders with flat, non-rounded tips.

12. A device comprising:
means for transmitting and receiving data and power; and
one or more connectors in signal communication with the means for transmitting data and power, the one or more connectors each comprising:
a mounting element;
a first set of terminals supported by the mounting element, each of the first set of terminals being equidistant from a center point of the connector, the first set of terminals configured to transmit and receive data; and
a second set of terminals supported by the mounting element, each of the second set of terminals being equidistant from the center point of the connector, at least two among the second set of terminals configured to transmit and receive power;
the connector configured to connect to another of the connector such that the first set of terminals electrically connects to a corresponding first set of terminals of the other connector and the second set of terminals electrically connects to a corresponding second set of terminals of the other connector.

13. The device of claim 12, wherein the connector further comprises a plurality of spring-loaded pins and a plurality of exposed contacts, each of the pluralities of pins and contacts connected to a corresponding terminal of the first and second sets of terminals.

14. The device of claim 13, wherein half of the first set of terminals and half of the second set of terminals are each connected to a corresponding pin of the plurality of spring-loaded pins, and the other half of the first set of terminals and the other half of the second set of terminals are each connected to a corresponding contact of the plurality of exposed contacts.

15. The device of claim 12, further comprising:
a processing unit having at least one wired data interface having at least two wires each connected to a corresponding terminal of the first set of terminals; and
an energy storage unit electrically connected to the processing unit and configured to store energy to power the processing unit, the energy storage unit further electrically connected to the second set of terminals;
the connector connecting to the other connector to enable the processing unit to exchange signals with a corresponding processing unit associated with the other connector via the at least one wired data interface and the first set of terminals.

16. The device of claim 15, wherein the connector connects to the other connector to enable the energy storage unit to charge and to be charged by a corresponding energy storage unit associated with the other connector via the second set of terminals.

17. The device of claim 16, wherein the energy storage unit recharges the corresponding energy storage unit when the corresponding energy storage unit is more depleted, and wherein the energy storage unit is recharged by the corresponding energy storage unit when the energy storage unit is more depleted.

18. The device of claim 17, further comprising a circuitry to recharge the energy storage unit using an external power source.

19. The device of claim 15, wherein the at least two wires of the at least one data interface are comprised by pairs of wires with each pair comprising a data transmitting wire and a data receiving wire.

20. The connector of claim 15, wherein the processing unit and the corresponding processing unit exchange data among them by transmitting or receiving a unique identification of the device, and other data to be relayed to other devices, and yet other data received from the other connected devices using a data exchange unit.
